(19) United States
(12) Patent Application Publication
(10) Pub. No.: US 2006/0291762 A1
(43) Pub. Date: Dec. 28, 2006

(54) Rolling element

(75) Inventors: Kenji Sunahara, Kitakyushu-shi (JP); Michiaki Ikeda, Kitakyushu-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: KABUSHIKI KAISHA YASKAWA DENKI, Kitakyushu-shi (JP)

(21) Appl. No.: 11/514,269

(22) Filed: Sep. 1, 2006

Related U.S. Application Data
(63) Continuation-in-part of application No. PCT/JP05/02793, filed on Feb. 22, 2005.

(30) Foreign Application Priority Data
Mar. 4, 2004 (JP) 2004-059922

(51) Int. Cl. F16C 33/62

(52) U.S. Cl. 384/492

(57) ABSTRACT

In some preferred embodiments of the present invention, a long-life rolling element which prevents a solid lubrication film from being broken away near the roots is provided. In a rolling element coated with a solid lubrication film in the form of a molybdenum disulfide sputter film, the solid lubrication film 3 is divided into two layers, a boundary layer 3A corresponding to the boundary between the firm and a roller 2 and an upper layer 3B. The boundary layer 3B has an oxygen content of 5 to 30% in atomic concentration, and the upper layer 3B has an oxygen content of 3% or less in atomic concentration.

### RELATED APPLICATIONS

This application is a continuation-in-part of a National Stage of International Patent Application No. PCT/JP2005/002793 filed on Feb. 22, 2005. This application claims priority under 35 U.S.C. §119 to Japanese Patent Application No. 2004-059922 filed on Mar. 4, 2004. Each of the entire disclosures of these applications is incorporated herein by reference in its entirety.

### BACKGROUND OF THE INVENTION

1. Field of the Invention

The present invention relates to a rolling element for use as, for example, a solid lubrication roller bearing which is to be preferably used under severe environments, such as, e.g., in vacuo, under radiations, at high temperatures, or in corrosive atmospheres. In the present invention, the language of “rolling element” denotes an element, such as, e.g., a roller, a ball, an inner ring, or an outer ring, which has opposed two faces for supporting tumbling motion.

2. Description of Related Art

The following description sets forth the inventor's knowledge of related art and problems therein and should not be construed as an admission of knowledge in the prior art.

Conventionally, there has been proposed technique for forming a lubrication film on a rolling element for use as a solid lubrication roller bearing which is to be used under severe environments, such as, e.g., in vacuo, under radiations, at high temperatures, or in corrosive atmospheres, for the purpose of providing a long-life and reliable rolling element with no variation in load bearing characteristics (see Japanese Unexamined Laid-open Patent Publication No. H06-272715). According to the proposal, in a rolling member having a lubrication film formed by coating molybdenum disulfide onto the rolling contact surface of the rolling member with which an opponent member is to be brought into contact, the lubrication film is formed by a molybdenum disulfide film having a composition in which the molecular weight ratio S/Mo of sulfur to molybdenum is set to be 1.7 or more but less than 2.0.

According to the proposal, it is said that a flat and fine solid lubrication film can be obtained, resulting in improved load bearing characteristics and an extended film life.

Generally, the frictional force caused by rolling acts on the root portion of the solid lubrication film as maximum shear stress. Therefore, in a conventional rolling element, a breakage at the root portion of the solid lubrication film and the separation thereof may sometimes occur, which in turn results in a relatively short life.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

### SUMMARY OF THE INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a long-life rolling element having a solid lubrication film capable of preventing breakage of the solid lubrication film at its root portion to thereby avoid the separation.

In general, the adhesion between metal and sulfide is very poor. However, the adhesion between metal and oxide is strong. Using this difference, the present inventors revealed that the adhesion between metal and sulfide can be improved by adding an appropriate amount of oxygen (5 to 30% in atomic concentration) into the sulfide. Less amount of oxygen in the sulfide results in insufficient adhesion between the sulfide and the substrate. On the other hand, excessive amount of oxygen results in amorphous substance, causing a reduced adhesion therebetween. Adding a certain amount of oxygen to the boundary portion near the substrate improves the life. The thickness of the boundary layer has an optimal range. If it is too thin, the adhesion to the boundary layer becomes insufficient. To the contrary, if it is too thick, friction increases. The optimal range of the thickness of this boundary layer varies depending on the structure elements of the solid lubrication film, and is decided by the material. The inventors found the fact that the optimal thickness range of the boundary layer is 0.01 to 0.2 μm in the case of molybdenum disulfide. Based on the above, the inventors have been completed the present invention. The present invention provides the following means.

According to a first aspect of a preferred embodiment of the present invention, a rolling element, comprising:

a substrate; and

a solid lubrication film coated on the substrate in the form of a molybdenum disulfide sputter film,

wherein the sold lubrication film is constituted by at least two layers including a boundary layer located near the substrate and an upper layer, and

wherein the boundary layer has an oxygen content of 5 to 30% in atomic concentration and the upper layer has an oxygen content of 3% or less in atomic concentration.

In this rolling element, the solid lubrication film firmly adheres to the substrate via the boundary layer, resulting in a hard-to-brake film, which in turn can extend the life of the rolling element.

It is preferable that the boundary layer is 0.01 to 0.2 μm in thickness.

In this case, the solid lubrication film firmly adheres to the substrate while keeping the friction small, which can extend the life of the rolling element.

The rolling element can be any one of the elements selected from the group consisting of a roller, a ball, an inner ring and an outer ring constituting a roller bearing.

According to a second aspect of a preferred embodiment of the present invention, a production method of a rolling element coated with a solid lubrication film in the form of a molybdenum disulfide sputter film, the method comprising the steps of:

forming a boundary layer having an oxygen content of 5 to 30% in atomic concentration on a substrate of the rolling element by a sputtering method; and thereafter

forming an upper layer having an oxygen content of 3% or less in atomic concentration on the boundary layer by a sputtering method,

wherein the boundary layer and the upper layer constitutes the solid lubrication film.

It is preferable that the step of forming the boundary layer is performed so that the boundary layer becomes 0.01 to 0.2 μm in thickness.

In the production method, the step of forming the boundary layer can be preferably performed in a vacuum chamber containing a certain amount of oxygen, and the step of forming the upper layer can be preferably performed in the vacuum chamber from which a certain amount of the oxygen is reduced.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by way of example, and not limitation, in the accompanying figures, in which:

FIG. 1A is a front view of a rolling element according to an embodiment of the present invention;

FIG. 1B is a side view of the rolling element shown in FIG. 1B;

FIG. 2 is a partially enlarged cross-sectional view of the rolling element;

FIG. 3 is a schematic structural view of a spatter device used in the embodiment;

FIG. 4A is a roller rolling jig used in this embodiment;

FIG. 4B is a cross-sectional view taken along the line A-A in FIG. 4A;

FIG. 5A is a side view of a rolling test machine used in this embodiment; and

FIG. 5B is a top view of the rolling test machine.

### DETAILED DESCRIPTION OF THE PREFERRED EMBODIMENTS

In the following paragraphs, some preferred embodiments of the present invention will be described by way of example and not limitation. It should be understood based on this disclosure that various other modifications can be made by those in the art based on these illustrated embodiments.

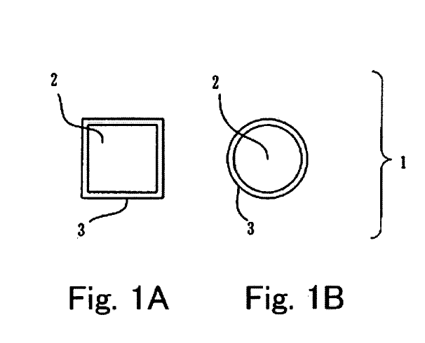

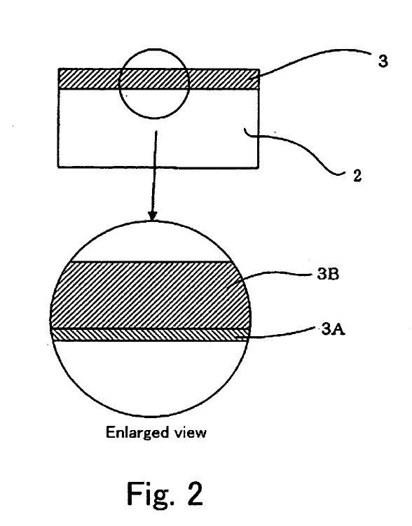

FIGS. 1A and 1B show a rolling element according to an embodiment of the present invention. FIG. 1A is a front view thereof, and FIG. 1B is a side view thereof. FIG. 2 is a partially enlarged cross-sectional view of the rolling element.

The rolling element 1 consists of a roller 2 made of steel and a solid lubrication film 3, in the form of a molybdenum disulfide spatter film, with a thickness of about 1 μm coated on the surface of the roller 2.

The rolling element 1 of this embodiment is different from a conventional rolling element in that the solid lubrication film 3 is divided into two layers, a boundary layer 3A corresponding to the boundary between the film 3 and the substrate of the roller 2 and an upper layer 3B, the boundary layer 3A having an oxygen content of 5 to 30% in atomic concentration and the upper layer 3B having an oxygen content of 3% or less oxygen in atomic concentration. Although the aforementioned “3% or less” includes “0%,” according to a sputtering method, oxygen will be contained up to about 1% even if careful attention is drawn so as to prevent mixing of oxygen into the upper layer 3B.

In this embodiment, the roller 2 is exemplified as a rolling element. It should be understood, however, that the rolling element according to the present invention can be any other element, such as, e.g., a ball, an inner ring, or an outer ring, since the same effects as in the present invention can be attained so long as it is provided with the solid lubrication film as defined by the present invention. Furthermore, although the substrate of the rolling element is made of steel material in this embodiment, such a substrate can be made of, for example, bearing steel or stainless steel (e.g., SUS440C).

### First Embodiment

Hereinafter, a first preferred embodiment of the present invention will be explained.

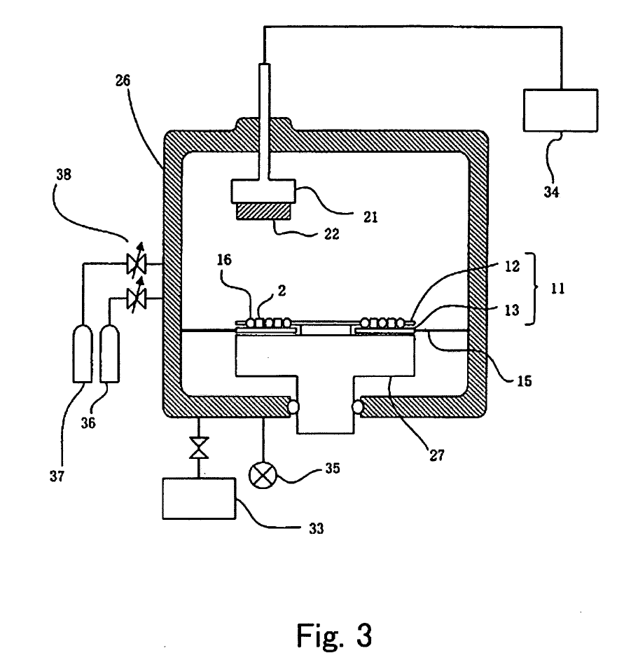

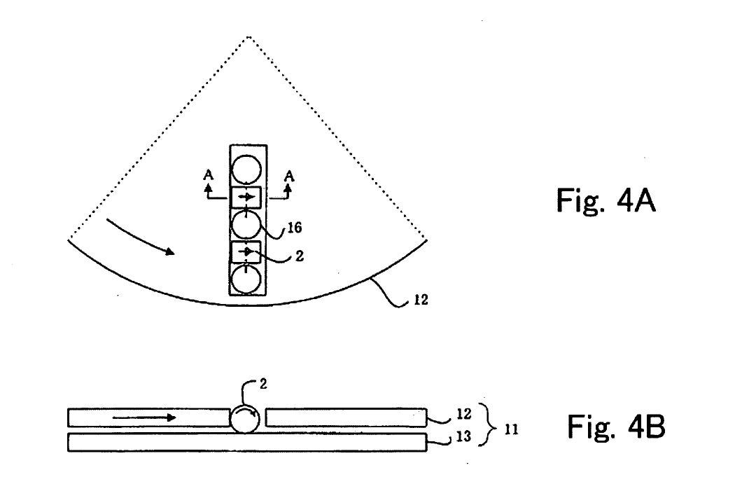

FIG. 3 shows a schematic structural view of a spattering device used in this embodiment, FIG. 4A shows a roller rolling jig used in this embodiment, and FIG. 4B is a cross-sectional view taken along the line A-A in FIG. 4A.

In FIG. 3, the reference numeral “11” a roller rolling jig, “12” denotes a rotating disk, “13” denotes a fixed disk, “15” denotes a fixing rod, “16” denotes a spacer ball, “21” denotes a cathode, “22” denotes a target, “26” denotes a vacuum chamber, “27” denotes a substrate holder, “33” denotes a vacuum pump, “34” denotes an RF power supply, “35” denotes a vacuum gauge, “36” denotes an argon cylinder, “37” denotes an oxygen cylinder, and “38” denotes a massflow controller.

The rolling element according to this embodiment is provided with a solid lubrication film coated on a roller (material: SUS440C) of a cross roller bearing, the solid lubrication film consisting of two layers containing molybdenum disulfide as a main ingredient.

As shown in FIG. 3, a target 22, which is a plate made of molybdenum disulfide, is attached to the cathode 21 of the RF power supply 34 disposed in the stainless steel vacuum chamber 26 for securing a vacuum atmosphere, and the roller rolling jig 11 is disposed on the upper portion of the substrate holder 27. Rollers 2 are placed in the roller rolling jig 11. With this state, a film will be coated on the cylindrical surface of each roller 2 by sputtering the molybdenum disulfide of the target material while rolling the roller 2.

The spatter device is provided with an argon cylinder 36 for introducing argon gas into the vacuum chamber 26 and an oxygen cylinder 37 for introducing oxygen into the vacuum chamber 26 at the outside of the vacuum chamber 26, respectively, so as to make oxygen contain in the boundary layer of the solid lubrication film of the roller 2. By introducing these gases into the vacuum chamber 26 during the spatter film coating process, oxygen can be contained in the boundary layer of the solid lubrication film. At the outside of the vacuum chamber 26, a vacuum gauge 35 for measuring the degree of vacuum in the vacuum chamber 26 and a vacuum pump 33 consisting of a rotary vacuum pump and a cryopump for vacuating the inside of the vacuum chamber 26 are provided.

In this spatter device, the inside of the vacuum chamber 26 is preferably vacuumed into 1×10⁻⁷ Pa. With this state, a prescribed amount of oxygen gas is introduced into the vacuum chamber 26, and then argon gas is introduced until the inner pressure of the vacuum chamber 26 reaches a prescribed pressure. In this state, RF power is applied to the cathode 21 to cause glow discharge therefrom for sputtering the surface of the target 22 by argon ion so that atoms constituting the target 22 made of molybdenum disulfide, i.e., molybdenum and sulfur, are beaten up to cause a deposit of molybdenum disulfide containing oxygen on the surface of the roller 2 by about 0.1 μm in thickness. Subsequently, sputtering is performed with the amount of oxygen reduced by a prescribed amount to thereby form a molybdenum disulfide film containing a small amount of oxygen in the upper layer.

As will be explained later, during the film forming process, the roller rolling jig 11 is used to uniformly form a molybdenum disulfide film containing the structural element on the cylindrical surface of the roller 2. The roller rolling jig 11 includes a rotating disk 12 and a fixed disk 13 as shown in FIG. 3. The rotating disk 12 is coaxially connected to the substrate holder 27 so that the rotating disk 12 can be rotated in accordance with the rotation of the substrate holder 27. On the other hand, the fixed disk 13 is fixed to the vacuum chamber 26 with fixing rods 15, so that the fixed disk 13 cannot be rotated in accordance with the rotation of the substrate holder 27.

In detail, as shown in FIG. 4, the rollers 2 and spacer balls 16 are arranged alternatively in the space formed by the slit of the rotating disk 12 and the upper surface of the fixed disk 13. In this state, when the substrate holder 27 is rotated, the rollers 2 are pushed by the rotating disk 12 rotating in accordance with the rotation of the substrate holder 27 while being rotated on its axis at a prescribed rotating speed and advanced in the peripheral direction of the rotating disk 12. During the film forming, a two-layered molybdenum disulfide film is uniformly formed on the cylindrical surface of each roller 2 by rolling the roller 2 as mentioned above. The film composition and the thickness of the boundary layer are measured by X-ray photoelectron spectroscopy (XPS).

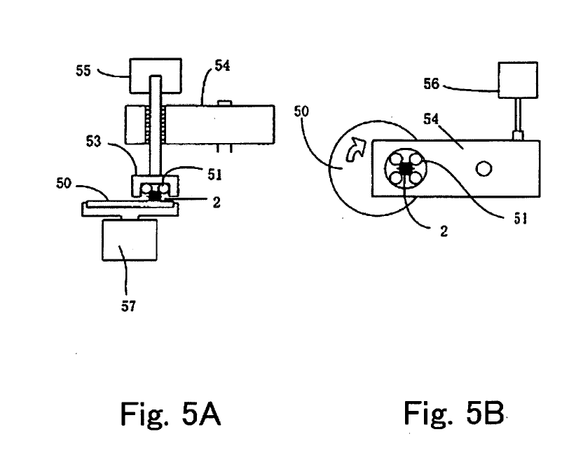

Samples each having a film 1 μm in entire thickness were produced by changing the amount of oxygen contained in the boundary layer and the upper layer. The total thickness of the boundary layer of each sample was about 0.1 μm. The life of each sample was investigated by the roller-on disc type film-life testing machine shown in FIGS. 5A and 5B. FIG. 5A shows the side view and FIG. 5B shows the top view.

In these figures, the reference numeral “50” denotes a disk, “51” denotes a ball, “53” denotes a roller holder, “54” denotes an arm, “55” denotes a dead weight, “56” denotes a load cell, and “57 denotes a motor. This film-life testing machine is configured to hold a roller 2, which is a rolling element, within the roller holder 53 in a state in which a total of four balls are in contact with the corners of the roller 2. In this machine, a load is applied to the roller 2 from the dead weight 55 located above the roller holder 53 and the frictional force produced by the rotation of the disk 50 in contact with the roller 2 is monitored by the load cell 56. Using this testing machine, the film-life was evaluated by the travel distance at the time that the load cell output became 0.8N or above under the conditions of about 8 m/min in rotation speed, 1.5N in applied load, and about 10% in relative humidity, The results are shown in Table 1. Table 1 shows the film component analysis results and the life in each sample.

TABLE 1

| | | Oxygen Atomic | | |
|---|---|---|---|---|
| | | Concentration at % | | |
| | | Boundary | Upper | |
| | Sample # | Layer | Layer | Life |
| Invention | 1 | 5 | 0.2 | 3,000 m or more⁽*⁾ |
| | 2 | | 1.4 | 3,000 m or more⁽*⁾ |
| | 3 | | 2.8 | 3,000 m or more⁽*⁾ |
| | 4 | 15 | 0.5 | 3,000 m or more⁽*⁾ |
| | 5 | | 1.3 | 3,000 m or more⁽*⁾ |
| | 6 | | 3.0 | 3,000 m or more⁽*⁾ |
| | 7 | 30 | 0.4 | 3,000 m or more⁽*⁾ |
| | 8 | | 1.6 | 3,000 m or more⁽*⁾ |
| | 9 | | 2.9 | 3,000 m or more⁽*⁾ |
| Comparative | 10 | 5 | 3.3 | 1,543 m |
| Example | 11 | 15 | 3.5 | 1,732 m |
| | 12 | 30 | 3.2 | 1,653 m |

| | | |
|---|---|---|
| 13 | 0.4 | 234 m |

Note:
⁽*⁾denotes that the test was terminated at the travel distance of 3,000 m

As shown in Table 1, all of the test pieces in which the oxygen atomic concentration in the upper layer was regulated to 3% or less were such long in life that it had not come to the end of the life even if the traveling distance exceeded 3,000 m.

In the rolling element coated with the solid lubrication film in the form of a molybdenum disulfide spatter film according to the first embodiment, the solid lubrication film was comprised of at least two layers, and the atomic concentration of oxygen contained in the boundary layer near the substrate was regulated so as to fall within the range of 5 to 30%, and the atomic concentration of oxygen contained in the upper layer was regulated to 3% or less. Accordingly, the solid lubrication film firmly adheres to the substrate via the boundary layer, resulting in a long-life rolling element.

### Second Embodiment

In this second embodiment, the influence of the thickness of the boundary layer was investigated. In the same manner as in the first embodiment, several samples were obtained. In this second embodiment, however, in each sample, the atomic concentration of oxygen in the boundary layer was fixed to 1% and the atomic concentration of oxygen in the upper layer was fixed to 15%. The thickness of the entire film was set to about 1 μm. The evaluation results are shown in Table 2. The samples #1 to #6 according to the present invention were 3,000 m or more in life.

TABLE 2

| | | Thickness of | Life |
|---|---|---|---|
| | Sample # | boundary layer (μm) | (m) |
| Comparative | 1 | 0.005 | 153 |
| example | | | |
| Invention | 2 | 0.01 | 3,000 m or more⁽*⁾ |
| | 3 | 0.02 | 3,000 m or more⁽*⁾ |
| | 4 | 0.05 | 3,000 m or more⁽*⁾ |
| | 5 | 0.1 | 3,000 m or more⁽*⁾ |
| | 6 | 0.2 | 3,000 m or more⁽*⁾ |
| Comparative | 7 | 0.3 | 1,235 m |
| example | | | |

Note:
⁽*⁾denotes that the test was terminated at the travel distance of 3,000 m

As shown in Table 2, in this second embodiment, since the thickness of the boundary layer was regulated to 0.01 to 0.2 μm, the solid lubrication layer keeps the friction force small and firmly adheres to the substrate, resulting in a long-life rolling element.

### INDUSTRIAL APPLICABILITY

The rolling element according to the present invention can be preferably used in a maintenance-free apparatus having a completely sealed non-exchangeable bearing.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

What is claimed is:

1. A rolling element, comprising:
a substrate; and
a solid lubrication film coated on the substrate in the form of a molybdenum disulfide sputter film,
wherein the sold lubrication film is constituted by at least two layers including a boundary layer located near the substrate and an upper layer, and
wherein the boundary layer has an oxygen content of 5 to 30% in atomic concentration and the upper layer has an oxygen content of 3% or less in atomic concentration.

2. The rolling element as recited in claim 1, wherein the boundary layer is 0.01 to 0.2 μm in thickness.

3. The rolling element as recited in claim 1, wherein the rolling element is one of the elements selected from the group consisting of a roller, a ball, an inner ring and an outer ring constituting a roller bearing.

4. The rolling element as recited in claim 2, wherein the rolling element is one of the elements selected from the group consisting of a roller, a ball, an inner ring and an outer ring constituting a roller bearing.

5. A production method of a rolling element coated with a solid lubrication film in the form of a molybdenum disulfide sputter film, the method comprising the steps of:
forming a boundary layer having an oxygen content of 5 to 30% in atomic concentration on a substrate of the rolling element by a sputtering method; and thereafter
forming an upper layer having an oxygen content of 3% or less in atomic concentration on the boundary layer by a sputtering method,
wherein the boundary layer and the upper layer constitutes the solid lubrication film.

6. The production method as recited in claim 5, wherein the step of forming the boundary layer is performed so that the boundary layer becomes 0.01 to 0.2 μm in thickness.

7. The production method as recited in claim 5, wherein the step of forming the boundary layer is performed in a vacuum chamber containing a certain amount of oxygen, and wherein the step of forming the upper layer is performed in the vacuum chamber from which a certain amount of the oxygen is reduced.

8. The production method as recited in claim 6, wherein the step of forming the boundary layer is performed in a vacuum chamber containing a certain amount of oxygen, and wherein the step of forming the upper layer is performed in the vacuum chamber from which a certain amount of the oxygen is reduced.
